(19) United States
(12) Patent Application Publication
(10) Pub. No.: US 2005/0278774 A1
(43) Pub. Date: Dec. 15, 2005

(54) Method and system for dynamic integration of external devices with a video device

(75) Inventors: Matthew A. Eshleman, Mt. Joliet, TN (US); Timothy Grams, Lebanon, TN (US)

Correspondence Address: NIXON & VANDERHYE, PC, 901 NORTH GLEBE ROAD, 11TH FLOOR, ARLINGTON, VA, 22203, US

(73) Assignee: Toshiba America Consumer Products, LLC, Wayne, NJ (US)

(21) Appl. No.: 11/130,397

(22) Filed: May 17, 2005

Related U.S. Application Data
(60) Provisional application No. 60/571,527, filed on May 17, 2004.

(51) Int. Cl. H04N 7/00; H04N 7/16

(52) U.S. Cl. 725/153; 348/552; 710/8

(57) ABSTRACT

A video device for connection to an external device includes an interface for connecting to the external device and software and/or firmware for functions of the external device. A control system is responsive to detection of a connection of the external device to the interface for automatically activating the software and/or firmware to enable use of the external device functions.

### CROSS-REFERENCE TO RELATED APPLICATIONS

This application claims the benefit of U.S. Provisional Application No. 60/571,527, filed May 17, 2004, the contents of which are incorporated herein in their entirety.

This application is related by subject matter to Application No. ______ (Attorney Docket No. 2414-76), filed concurrently herewith, which claims the benefit of U.S. Provisional Application 60/571,528, filed May 17, 2004. The contents of these applications are incorporated herein in their entirety.

### BACKGROUND AND SUMMARY

This application generally relates to external devices for connection to a video device such as a television, a monitor or a set-top box and, more specifically, to a method and system for dynamically integrating external devices with the video device.

Consumers often have a number of devices connected to video devices such as televisions. For example, it is not uncommon for a television to be connected to a set-top box for receiving satellite or cable television signals, a DVD player and a VCR. It is becoming popular to record programming onto hard disks that enable features such as pausing live television and recording and playback of television programs. Devices incorporating these hard disks are also connected to televisions. It can sometimes be difficult for users to connect these devices to their televisions. In addition, users often do not configure these devices to take full advantage of the features thereof.

The methods and systems described herein provide for dynamic integration of external devices with video devices such as televisions, monitors and set-top boxes. In a particular example embodiment, the control program of the video device is provided with certain functions or operations that utilize one or more external devices that can be connected thereto. The video device automatically activates these features when it detects that the external device is connected thereto. In this way, the user needs to go through only minimal (and sometimes no additional) steps to use the external device.

These and other features and advantages will be better and more completely understood by referring to the following detailed description of example embodiments in conjunction with the drawings.

### BRIEF DESCRIPTION OF THE DRAWINGS

FIG. 1 is a block diagram showing a video device connected to an external device.

FIG. 2 is a highly generalized block diagram of a television which is an example of the video device 200 shown in FIG. 1.

FIG. 3 is a block diagram of an external storage device which is an example of the external device 300 shown in FIG. 1.

FIG. 4 shows an example display screen generated when the external storage device is connected to the television.

FIG. 5 is high-level flow diagram of what happens when an external storage device is connected to a television.

FIG. 6 is a high-level flow diagram of what happens when the customer presses the PAUSE key;

FIG. 7 is a high-level flow diagram of what happens when the user presses the PLAY key after a PAUSE;

FIG. 8 is a high-level flow diagram of what happens when the user presses the LIVE or GO-LIVE key when a television is paused or playing video from the record buffer.

### DETAILED DESCRIPTION OF EXAMPLE EMBODIMENTS

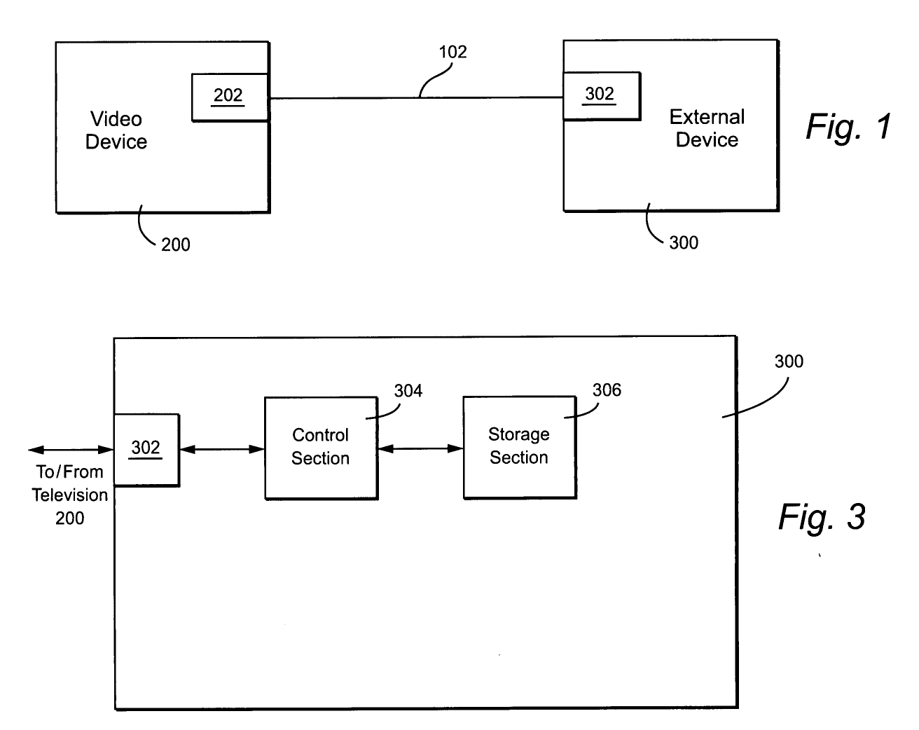

FIG. 1 is a block diagram showing an external device 300 having an externally accessible interface 302 connected by a cable 102 to an externally accessible interface 202 of a video device 200. In an example embodiment described below, video device 200 is a television and external device 300 comprises a storage device (such as a hard disk) for storing audio-visual (AV) data. AV data as used herein includes not only audio and visual data, but also standard MPEG program specific information (PSI) that provides information about the data stream such as type of video, type of audio, conditional access information, content advisory information, closed-caption information and the like. The external storage device also separately stores “track” information, which includes program title information, program duration information, and other descriptive information that can be used by the television, for example, to generate display screens and menus to assist users in selecting programs for playback from the external storage device.

In other implementations, the external storage device can store music data (such as MP3 files), image data (such as JPEG or TIFF files) and other standard personal computer files. Of course, if such data were stored, the television would provide a suitable user interface for storing the data and for accessing the stored data for playback, display or other processing (e.g., e-mailing to others). Video device 200 is not limited to a television and may be a set-top box, a monitor and the like. Similarly, external devices other than storage devices may be used, such as DVD players, VCRs and the like. As described in greater detail below, in the example embodiment, when connected to the television, the external storage device permits a user to use a variety of functions, including so-called personal video recording (PVR) functions for the recording and playback of AV data.

Although interface 202 is shown in FIG. 1 as being of the type for wired communications over cable 102, interface 202 may be of any type suitable for wired or wireless communications of AV data and related commands between the television and the external storage device. Such interfaces include by way of example, not limitation, IEEE 1394, USB, 802.11g, and UWB (ultra-wideband) connections. In addition, the interface may include separate paths for different types of data. Thus, for example, AV data may be communicated over one connection (e.g., an IEEE 1394 connection) and commands may be communicated over another separate connection (e.g., a Bluetooth® connection). Bluetooth is a registered trademark of Bluetooth SIG, Inc.

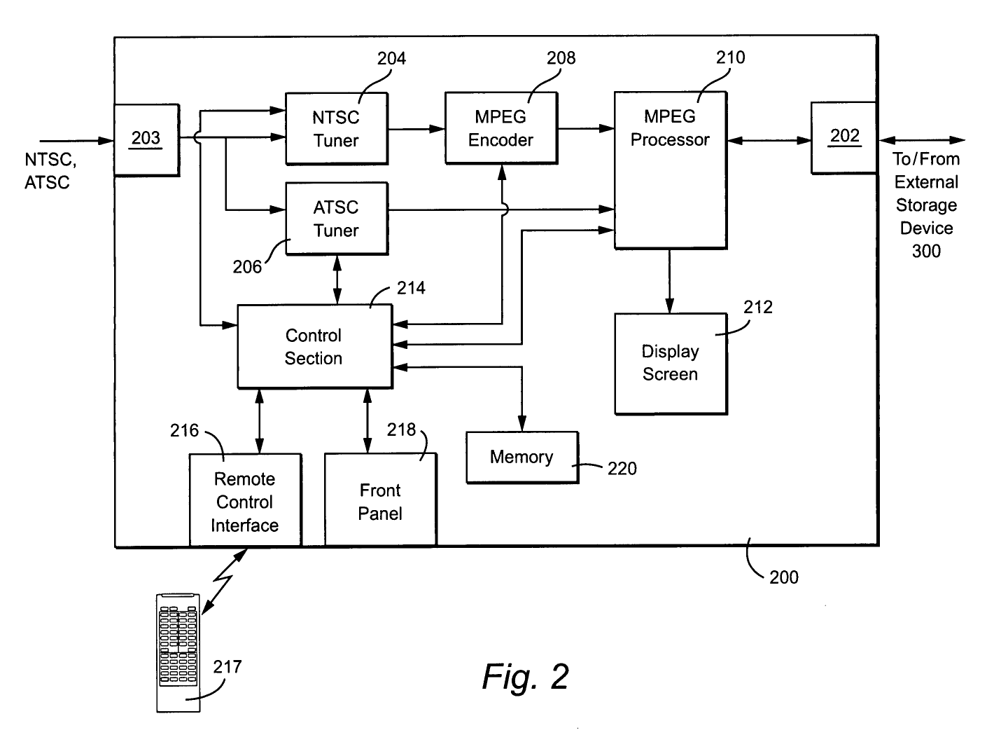

FIG. 2 is a highly generalized block diagram of a television which is an example of the video device 200 shown in FIG. 1. The television is hereinafter referred to as television 200. An input 203 of the television receives NTSC and ATSC signals. The NTSC signals are supplied to an NTSC tuner 204 and the ATSC signals are supplied to an ATSC tuner 206. Other inputs (not shown) may also be supplied to the television. For example, the television may receive HDMI signals or the output from a DVD player. The output of NTSC tuner 204 is supplied to an MPEG encoder 208 which MPEG encodes the tuned NTSC signal. The outputs of ATSC tuner 206 and MPEG encoder 208 are supplied to an MPEG processor 210. MPEG processor 210 processes the MPEG transport stream from the ATSC tuner 206 and/or MPEG encoder 208 and supplies a display signal to display screen 212. MPEG processor 210 also selectively outputs an MPEG transport stream to and receives an MPEG transport stream from external storage system 300 via interface 202. Generally speaking, MPEG processor 210 is a standard processing device used in conventional digital integrated television, monitors and STB units that receives MPEG compressed AV data and decompresses and processes the AV data for display.

A control section 214, including a CPU, for example, controls the overall operations of television 200. In general, control section 214 may include, for example, a microprocessor, a microcontroller, an application specific integrated circuit (ASIC), logic circuitry, a state machine and/or combinations thereof. Control section 214 may be supplied with user inputs via a remote control interface 216 for a remote control 217 (e.g., an infrared remote control) and front panel keys 218. In the example embodiment, the remote control 217 includes various input devices such as keys and buttons that can be used by the user to input various PVR commands (e.g., RECORD, PLAY, REWIND, FAST FORWARD, etc.). The keys or buttons of the remote control used for inputting these commands may be appropriately labeled to assist the user in selecting a desired function. Alternatively or in addition, the television may provide one or more displays that inform the user which key(s) or button(s) should be actuated to effect desired PVR functions. Other types of inputs such as voice inputs may also be used to input PVR commands in certain implementations. In still other implementations, remote control interface 216 may be adapted to send commands (e.g., IR commands) to control other devices such as VCRs.

Memory 220 which may be a combination of volatile and non-volatile semiconductor memory stores various operating programs and user settings used by control section 214 to control the operation of television 200.

In the example embodiment, television 200 is also provided with an electronic program guide. Generally speaking, an electronic program guide uses program guide data transmitted to the television to provide the user with on-screen displays of television program schedules. For example, the on-screen display may be in the form of a grid in which channels are arranged vertically and time extends horizontally. Titles of programs are shown in cells in the grid and the horizontal dimension of the cell is indicative of the length of the corresponding program. The electronic program guide may also enable a user to select programs from the grid (or from some other display of program titles) for viewing and recording. In the case of selecting a program from the program guide for viewing, the television is controlled to tune to the channel showing the selected program. In the case of selecting a program for future recording, a program timer is generated with relevant recording information (e.g., start time, end time, channel). At the program start time, the television is controlled to tune to the selected channel and command(s) may be issued to turn on and place a recording device in record mode (e.g., to a VCR via remote control interface 216 or to the external storage device via interface 202). At the program end time, command(s) may be issued to stop the record mode and turn off the recording device. In addition, electronic program guides also often provide the capability of displaying listings of programs by themes and titles. Electronic program guides are available from various providers including Gemstar-TV Guide.

FIG. 3 is a block diagram of an external storage system which is an example of external device 300 shown in FIG. 1. The external storage device is hereinafter referred to as external storage device 300. External storage device 300 includes an interface 302 for communications with television 200 over cable 102. As with interface 202, interface 302 may be a wired or wireless interface as appropriate. A control section 304 controls the external storage system 300. Control section 304 may be implemented, for example, as a microprocessor, a microcontroller, an application specific integrated circuit (ASIC), logic circuitry, a state machine and/or combinations thereof. Control section 304 is responsive to commands from television 200 received via interface 302 for effecting operations involving AV data in a storage section 306. For example, a first such operation stores AV data in storage section 306 and a second such operation reads stored AV data from storage section 306 for playback on television 200. In the example embodiment, storage section 306 includes one or more hard disks, but is not limited thereto and may comprise any magnetic, optical, or semiconductor memory, as well as combinations thereof. The hard drive may have a capacity of, for example, 80 GB, 120 GB or larger. External storage system 300 also includes a power supply (not shown) for supplying power to control section 304 and storage section 306. The power supply may be powered via a connection to an ordinary electrical outlet or by one or more batteries.

As noted above, external storage device 300 may be connected to television 200 in order to provide PVR functions for a user. These PVR functions allow users to store and playback AV data. The user uses remote control 217 to enter various commands relating to the PVR functions. These commands are input to remote control 217 and are transmitted by a transmitter (e.g., an infrared transmitter) of the remote control to remote control interface 216 of television 200. The commands are then sent from the interface 216 to the control section 214 of the television. The control section decodes the received command and takes appropriate action(s) in response thereto which may include, for example, generating, encoding and sending commands to external storage device 300 via interface 202.

Control section 304 of the external storage device 300 takes appropriate action(s) in response to commands received from television 200. These actions include storing AV data received from television 200 into storage section 306, playing back AV data stored in storage section 306, providing status information (e.g., the free space/used space of storage section 306), deleting programs/streams/tracks, setting up “looping record buffers”, storing track information (titles, durations, timestamps, etc) and the like.

In the example embodiment described herein, control section 214 of television 200 contains software, firmware and/or hardware that enables a user to perform at least the following functions or operations:
PAUSE live television;
RECORD programs to the external storage device;
register the external storage device with an electronic program guide to permit automatic recording via program guide selections;
view programming recorded on the external storage device;
provide various graphical user interfaces (GUIs) to control SEARCH, (FAST) REWIND, FAST-FORWARD, PAUSE, SLOW-MOTION and PLAY;
provide various GUIs to allow selection of a program on the external storage device; and
provide various GUIs to control “live television” such as rewinding and fast-forwarding.

By way of example, the PLAY function begins playback of AV data stored on external storage device 300. The SEARCH function is used to locate a particular portion of the stored AV data and playback will then begin at that point. Using the SEARCH function, for example, a user can skip forward or backward during playback. In one example implementation, the user can configure the amount of time (e.g., 1, 3, 5 or 15 minutes) the device will skip each time the SEARCH function is invoked (e.g., by pressing the forward and backward SKIP/SEARCH keys on a remote control). The FAST FORWARD and FAST REWIND functions permit movement forward and backward through the AV data. FAST FORWARD and FAST REWIND may be performed at a variety of speeds (e.g., 5 times normal speed, 10 times normal speed, etc.) and at least some of these speeds may be configured by the user. Thus, the television may provide various display screens that prompt the user to select one or more speeds. The selected speeds are then stored in memory 220 of television 200 and are referred to by control section 214 when FAST FORWARD and/or FAST REWIND are used. The SLOW-MOTION function permits viewing of AV data in slow motion at a variety of different speeds ranging from, for example, ⅛ normal speed to single-frame advance. At least some of the slow-motion speeds may be user configurable. The PAUSE function permits forwarding and rewinding to be stopped and freezes play at the nearest I-frame. In an example embodiment, a screen saver may be displayed if the AV data is paused for longer than a predetermined period of time (e.g., two minutes). The RECORD function permits recording of an AV stream onto external storage device 300. The STOP function stops the flow of data to or from external recording device 300. There may also be various functions for storing descriptive information with each recorded program (title, duration, timestamp and the like).

The software and/or firmware for the various functions described above is built into the television 200 (e.g., at the time of manufacture), but is initially deactivated by, for example, not executing the code that performs the functions. In addition, the hardware used for the various functions (e.g., interface 202) may or may not be deactivated depending on other functions that the television 200 supports. When television 200 detects that the external storage device 300 is connected to the television 200 (e.g., through standard 1394 device connection mechanisms), the relevant software, firmware and/or hardware is activated. More specifically, when the television detects that a new device is connected to its connector 202, the television determines whether the device is an external storage device by, for example, sending a request to the device to identify itself. If so, a message is sent to the control section 214 (e.g., application state machine) of the television, which then detects that an external storage device is connected and activates the various functions as appropriate (e.g., live pause, program guide integration, channel change handling of the looping record buffer, etc.) Thus, when external storage device 300 is connected to television 200, television 200 automatically (without any reboots or re-starts) performs the following:
activates all the functions noted above;
when viewing any antenna or cable program, automatically sends the MPEG transport stream for the program to the external storage device (i.e., television 200 resets the live television looping record buffer with every channel change, selects either the direct output of the ATSC tuner or the output of the MPEG encoder depending on the channel source type and sends the selected output to the external storage device). In the example embodiment, MPEG transport streams for antenna and cable programs are supplied to the external storage system when connected. That is, when the user is watching an RF channel (ANT/cable), the transport stream is supplied to the external storage system. If the user is watching, for example, the output of a DVD player, the MPEG transport stream is not sent to the external storage device. Of course, it will be apparent that television 200 may be readily modified to provide such signals to the external storage device; and
automatically locks a tuner when electronic program guide software issues a recording request so that the program can be recorded to the external storage device without interruption.

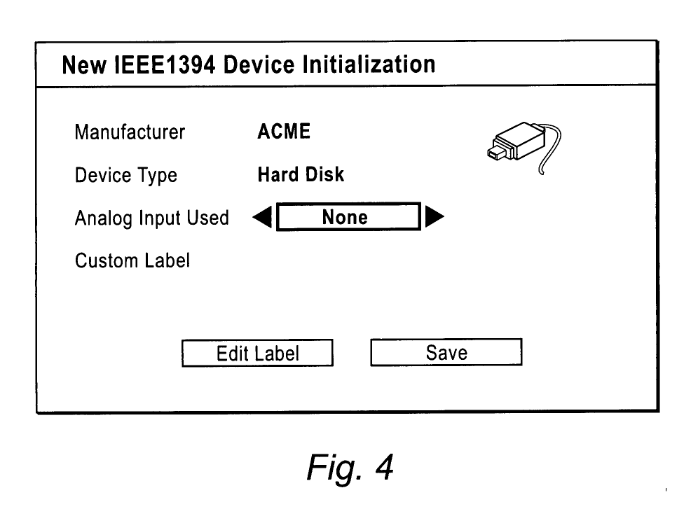

FIG. 4 shows an example display screen automatically generated when the external storage device is successfully connected to the television. In this way, the user can be informed of the successful connection of the external storage device to the television. Additionally, this screen enables a user to provide a user-selected or custom label (name) for the external storage device.

The looping record buffer mentioned above is a buffer that is created on the external storage device that loops around automatically when the buffer is full, and then overwrites the older material in the buffer. This is a convenient type of recording buffer to use, for example, for pausing live television. In the example embodiment, the television control system 214 dynamically destroys, creates and re-sizes the buffer with every channel change and this function is automatically activated when external storage device 300 is connected to television 200. The buffer size may, for example, be set so that approximately sixty minutes of AV data will be stored and thus the buffer size will vary depending on the bit rate of the current channel.

Television 200 automatically deactivates some or all of the software, firmware and/or hardware for the features used by the external storage system upon disconnection of the external storage system from the television.

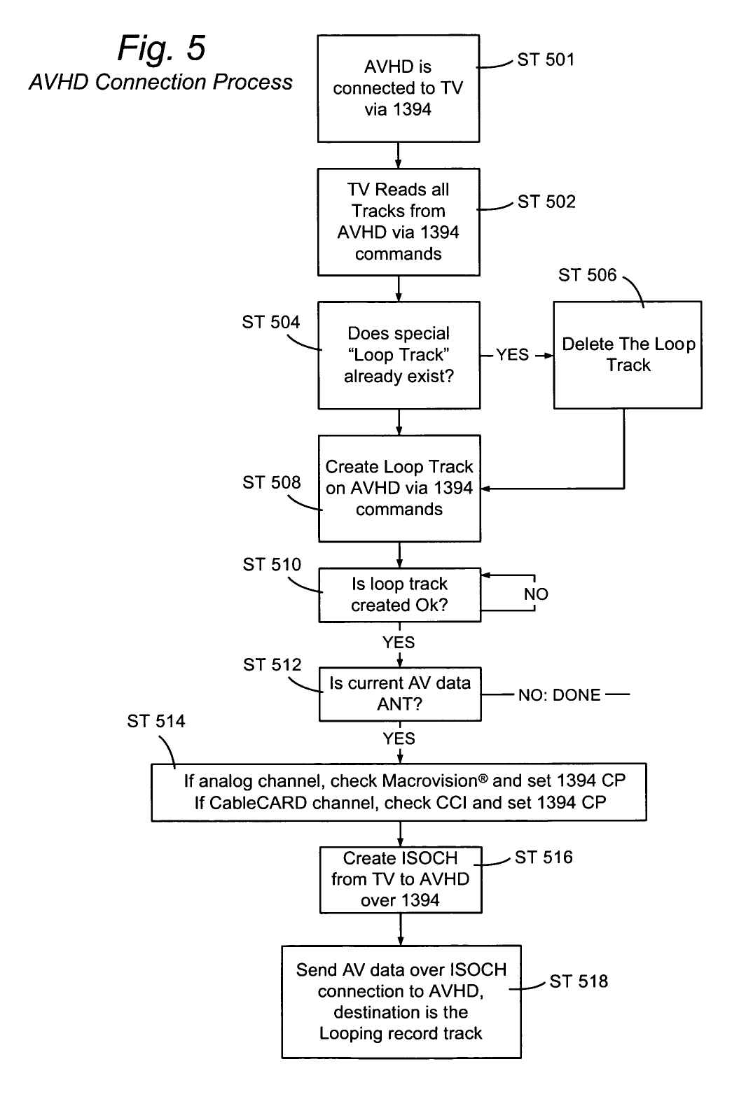

FIG. 5 is a high-level flow diagram showing what happens when an external storage device is connected to the television. At ST 501, the external storage device (also referred to as AVHD—Audio-Visual Hard Drive) is connected to connector 202 of television 200, in this case, a 1394 connector. As noted above, when the connection is made, various features are automatically activated as noted above. At ST 502, television 200 reads all the tracks from the external storage device via commands sent over the cable 102. Television 200 then determines whether a recording loop track already exists at ST 504 and, if so, the recording loop track is deleted at ST 506. At ST 508, a recording loop track is created on the external storage device via commands sent over the cable 102. After confirmation that the loop track has been correctly created at ST 510, television 200 determines whether the current video is from an RF channel at ST 512. If not, the process is completed. If so, control proceeds to ST 514. At ST 514, if the channel is determined to be an analog channel, the Macrovision® copy protection is checked and the 1394 copy protection (CP) is set accordingly. If the channel is determined to be a CableCard channel, the CCI (Copy Control Information) is checked and the 1394 copy protection is set accordingly. Next, an isochronous (ISOCH) channel is created from the television to the external storage device over the cable 102 at ST 516. AV data is sent over the ISOCH connection to the external storage device at ST 518. The destination of this AV data is the looping record buffer.

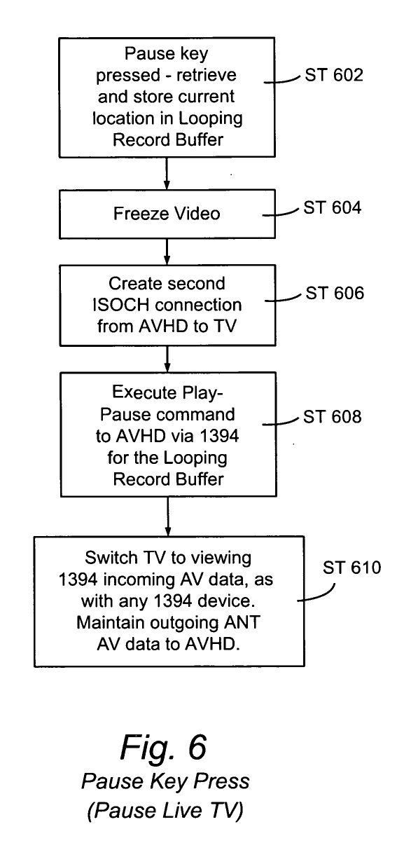

FIG. 6 is a high-level flow diagram showing what happens when the Pause command is entered using remote control 217. At ST 602, the Pause command is entered and television 200 retrieves and stores the current location in the looping record buffer. The video is then frozen at ST 604 and a second ISOCH connection is created from the external storage device to television 200 at ST 606. A command is sent to the external storage device via the cable 102 for the looping record buffer at ST 608 and television 200 is switched to viewing incoming video from the external storage device 300 at ST 610. The outgoing MPEG transport stream is maintained to the external storage device.

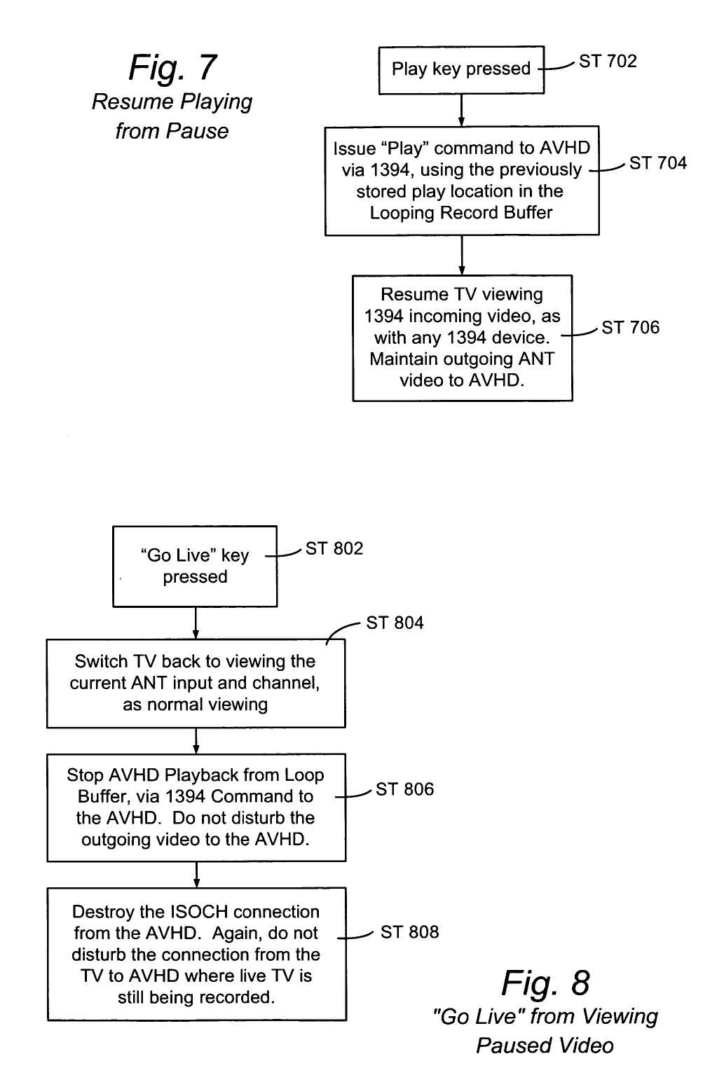

FIG. 7 is a high-level flow diagram of what happens when the user enters the PLAY command after a PAUSE. At ST 702, the PLAY command is entered. The PLAY command is issued to the external storage device using the previously stored play location in the looping record buffer at ST 704. At ST 706, television viewing is resumed with incoming video from the external storage system over the cable 102 and outgoing video is maintained to the external storage device.

FIG. 8 is a high-level flow diagram of what happens when the user enters the LIVE or GO-LIVE key when the television is paused or playing video from the looping record buffer. At ST 802, the “Go Live” command is entered. Then, television 200 is switched back to viewing the current ANT input and channel, as in normal viewing at ST 804. Playback from the external storage device is stopped using a command sent over the cable 102 at ST 806. The outgoing video to the external storage device is not disturbed. The ISOCH connection from the external storage device to the television is destroyed at ST 808. Here again, the connection from television 200 to external storage device is not disturbed.

While the above discussion has been with reference to example embodiments, it is to be understood that variations of the example embodiments will be readily apparent and this application is intended to cover various modifications and equivalent arrangements included within the spirit and scope of the appended claims.

1. A video device for connection to an external device, comprising:
an interface for connecting to the external device;
at least one of software and firmware for functions of the external device; and
a control section responsive to detection of a connection of the external device to the interface for automatically activating the software and/or firmware to enable use of the external device functions.

2. The video device according to claim 1, wherein the interface comprises a wired interface.

3. The video device according to claim 1, wherein the interface comprises a wireless interface.

4. The video device according to claim 1, wherein the software and/or firmware comprises executable instructions for personal video recorder functions.

5. The video device according to claim 1, wherein the control section deactivates the software and/or firmware in response to detection of a disconnection of the external device to the interface.

6. The video device according to claim 1, wherein the video device comprises a television.

7. The video device according to claim 1, wherein the video device comprises a monitor.

8. The video device according to claim 1, wherein the video device comprises a set-top box.

9. A video device for connection to an external storage system, comprising:
an interface for connecting to the external storage device; and
a control section for controlling operations of the video device, the control section comprising a plurality of initially deactivated, built-in functions associated with the external storage system,
wherein the control section is responsive to detection of a connection of the external storage system to the connector for automatically activating the functions associated with the external storage system.

10. The video device according to claim 9, wherein the initially deactivated functions comprise personal video recording functions.

11. The video device according to claim 9, wherein the control section is responsive to a detection of a disconnection of the external storage system from the connector for deactivating the functions for controlling the external storage system.

12. The video device according to claim 9, wherein the initially deactivated functions comprise a display screen generating function for generating a display screen indicating that the connection of the external storage system to the interface is detected.

13. The video device according to claim 9, wherein the interface comprises a wireless interface.

14. The video device according to claim 9, wherein the interface comprises a wired interface.

15. The video device according to claim 9, wherein the video device comprises a television.

16. The video device according to claim 9, wherein the video device comprises a monitor.

17. The video device according to claim 9, wherein the video device comprises a set-top box.

18. The video device according to claim 9, wherein the initially deactivated functions comprise a function for automatically sending audio-visual data to the external storage system.

19. A method for connecting an external storage system to a video device having a plurality of initially deactivated, built-in functions associated with the external storage system, the method comprising:
detecting a connection of the external storage system to the video device; and
in response to the connection detection, automatically activating the built-in functions of the video device associated with the external storage system.

20. The method according to claim 19, further comprising:
detecting a disconnection of the external storage system from the video device; and
in response to the disconnection detection, automatically de-activating the built-in functions of the video device associated with the external storage system.

21. A personal video recording system comprising:
a storage device for storing audio/visual data; and
a control system for fast forwarding and rewinding through the audio/visual data stored on the storage device,
wherein one or more fast forwarding or rewinding speeds are configurable in response to user inputs.

22. The personal video recording system according to claim 21, wherein the one or more fast forwarding or rewinding speeds are configurable in multiples of a normal play speed.

23. The personal video recording system according to claim 21, further comprising:
a memory for storing the user inputs.
